(19) United States
(12) Patent Application Publication
(10) Pub. No.: US 2013/0054388 A1
(43) Pub. Date: Feb. 28, 2013

(54) Commerce and inventory control system and a method for conducting commerce

(71) Applicants: Verdi Erel Ergun, Ypsilanti, MI (US); Erol Zafer Ahmed, Shelby Twp, MI (US)

(72) Inventors: Verdi Erel Ergun, Ypsilanti, MI (US); Erol Zafer Ahmed, Shelby Twp, MI (US)

(21) Appl. No.: 13/199,209

(22) Filed: Aug. 23, 2011

(51) Int. Cl. G06Q 30/00

(52) U.S. Cl. 705/16; 705/27.2

(57) ABSTRACT

A system 10 having a cloud computing assembly 16 and at least one portable computing device 12 which is in communication with the assembly 16 and which cooperates with the assembly 16 to take orders, manage inventory, and allow a user to manage the overall business.

### GENERAL BACKGROUND

### Field of the Invention

The present invention generally relates to a commerce and inventory control system and a method for conducting commerce, and more particularly, to a commerce and inventory control system which efficiently and accurately manages inventory while concomitantly facilitating sales and providing desired analytical information which is useful to an owner to manage a business, and which may be used in accordance with an overall method to conduct commerce.

### BACKGROUND OF THE INVENTION

Commercial establishments, such as coffee shops, typically have cash registers which are adapted to tally orders and to receive and temporarily store money. Orders are typically taken by hand, written down on paper, given to the customer, and received back with the payment. The payment is then placed within the cash register. Not only is this “paper type ordering” inefficient, but valuable information such as the identity of the customer and associated food and beverage preferences are lost. Moreover, accurately tracking inventory and having accurate sales forecasts are critical to efficiently managing a business, and these cash registers simply do not provide this desired functionality. At best, these business owners are required to keep track of their inventory by use of a “paper and pen ” method and to separately, by use of yet another system, attempt to obtain some analytical sales information. These systems are also not adapted to market the business through newer “social networking” websites and were created long before “viral marketing” was ever employed.

There is therefore a need and it is a principal and non-limiting object of the present invention to provide a commerce and inventory control system which overcomes the various disadvantages of prior commerce and inventory strategies, including but not limited to those which have been previously delineated.

### SUMMARY OF THE INVENTION

It is a first non-limiting object of the present invention to provide a commerce and inventory control system which allows orders to be electronically created by a portable device and which allows the same portable device to be operatively coupled to a cash register while concomitantly and dynamically allowing the device to be used to provide “real time” inventory information.

It is a second non-limiting object of the present invention to provide a method for conducting commerce in which a portable device is used to manage a business and such management includes, but is not limited to, using the portable device to manage inventory, to create orders, and to provide analytical business information once the device is connected to a cloud computing environment. In another embodiment, the system can also manage employees and/or provide information and certain tools to allow a business owner to manage employees.

According to a first non-limiting aspect of the present invention, a system is provided and includes a processor portion; a communication portion which is coupled to the processor portion; and a display portion which is coupled to the processor portion and wherein the processor portion contains first information which represents a respective quantity of items which are resident within a business establishment and which causes the first information to be selectively communicated to and displayed upon the display portion, and wherein the processor portion further contains second information which represents a plurality of items which are for sale along with a respective price for each of the plurality of items, and wherein the processor causes the second information to be selectively communicated to and displayed upon said display portion, and wherein the display portion allows an order to be selectively created by allowing for at least one of said plurality of items to be selected and which further communicates the order to the processor portion which creates a bill and saves the order information.

According to a second non-limiting aspect of the present inventions, a system is provided and includes a first portion which receives and stores inventory information, menu item information, the identity of a plurality of customers, and the respective menu items purchased by each of the respective plurality of customers over a certain period of time; a display portion which is coupled to the first portion and which selectively displays the inventory information, the menu item information, the identity of the plurality of customers, and the respective menu items purchased by each of the respective plurality of customers, wherein the display portion allows an order to be created by the selection of at least one of the displayed menu items; a third portion which is coupled to the first portion and to the display portion and which generates an invoice/bill/receipt associated with the order and which electronically mails the invoice to one of the plurality of customers; and a cash register portion which is coupled to the first portion and which selectively opens and closes and which receives money associated with the invoice.

According to a third non-limiting aspect of the present inventions, a method is provided for managing inventory and selling items comprising the steps of obtaining inventory information; storing the obtained inventory information; updating the inventory information; replacing the stored inventory information with the updated inventory information; displaying the updated inventory information on a computing device; creating a menu which comprises a list of items and the respective purchase prices respectively associated with each of the items; storing the menu; displaying the menu upon the computing device; creating an order comprising certain items which are selected by use of the displayed menu; creating a bill by use of the computing device; electronically mailing the created bill to a customer; receiving payment for the order; and delivering the order.

These and other features, aspects, and advantages will become apparent from a reading of the following detailed description of the preferred embodiment of the various inventions, including the subjoined claims, and by reference to the following drawings.

### BRIEF DESCRIPTION OF THE DRAWINGS

FIG. 1 is a block diagram of the system which is made in accordance with the teachings of the preferred embodiment of the invention.

FIG. 2 is a schematic block diagram of the computing device portion of the system which is shown in FIG. 1.

FIGS. 3(a-d) are various informational displays which are selectively created by the system of FIG. 1.

FIG. 4 is another information display which is selectively created by the system of FIG. 1.

FIG. 5 is a block diagram of a system made in accordance with the teachings of an alternate embodiment of the invention.

### DETAILED DESCRIPTION OF THE PREFERRED EMBODIMENT OF THE INVENTIONS

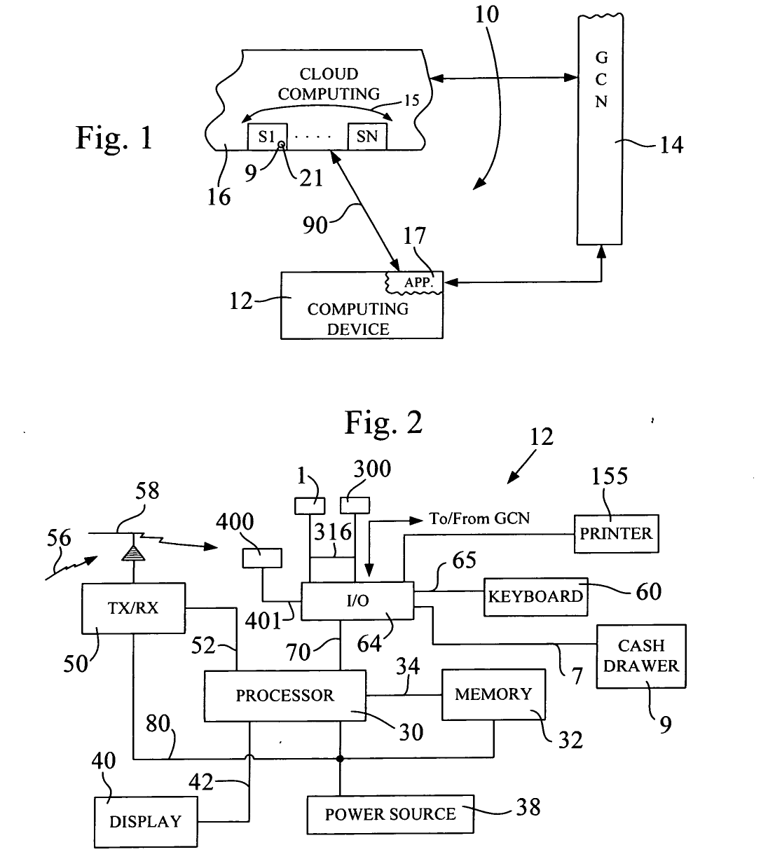

Referring now to FIG. 1, there is shown a commerce and inventory control system 10 which is made in accordance with the teachings of the preferred embodiment of the inventions.

Particularly, the system 10 includes a hand held or otherwise portable (e.g., a notebook type, smartphone type, and/or laptop) type computing device 12 which is adapted to be selectively and communicatively coupled to a global communications network, such as that which is referred to as “The Internet” 14 and/or directly coupled to an array of servers 15 which are generally and cooperatively configured as and generally referred to as a “cloud computing network” 16. Of course, the cloud computing network 16 may also be communicatively coupled to the global communications network 14 and the device 12 may access the cloud computing network 16 either through the global communications network 14 and/or directly as part of what is referred to as an “intranet” which is a functioning subpart of the Internet. There could exist, in other embodiments, a dedicated communications channel or connection (such as a T1 line or a shared wireless connection) 90 between the device 12 and the assembly 15. As will be seen, in one non-limited embodiment of the invention, the device 12 operatively contains at least one software application 17 which cooperates with a software application 9 and data 21, shown best in FIG. 1, resident within the array of servers 15, and accessible by some or all of the servers 15, effective to cooperatively provide the desired level of functionality to a user of the system 10. The data 21 is utilized by the software application 9 and/or the software application 17.The system 10 therefore, in this one non-limited embodiment, includes the combination of the handheld/portable device 12 (including the application 17) and the data 21 and at least one application 9 which reside upon/within the array of servers 15.

In a first non-limiting embodiment, only a single server is utilized in the system 10, however nothing in this description is meant to limit the number of such servers 15 which are utilized, or the number of such portable/handheld devices 12 which are utilized, or the number of applications 17 or data /applications 21 which are utilized. What follows is just a description of one non-limiting embodiment of the various inventions. That is, what follows is just a description of the interaction of a single device 12 interacting with the cloud assembly 16. However, it should be appreciated that in practice multiple such devices 12 may be utilized and that different devices 12 might have access to different types or “levels” of the data 21 and/or to different applications 9. Moreover, in various embodiments, devices 12 which are utilized may even be of different types.

Referring now to FIG. 2, there is shown a first non-limiting example of such a handheld/portable device 12. As shown, device 12 includes a processor 30 which is operable under stored program control and which may comprise a commercially available processor, such as that which is referred to as an “I5” and which is manufactured by the Intel® Corporation. Device 12 further includes a memory portion 32 which is coupled to the processor 30 by use of the bus 34. Data may be selectively written into and read from the memory portion 32 by the processor 30 and software may reside within the memory portion 32 which defines the overall operation of the device 12.

Further, the device 12 includes a source of electrical power 38 and a display portion 40. In one non-limiting embodiment, device 12 can be connected or communicate with a multitude of display portions, like kitchen monitors and digital menus and thus a plurality of similar or dissimilar displays may be operatively coupled to processor 30. Particularly, the display portion 40 is coupled to the processor 30 by use of the bus 42 and is adapted to selectively display information which is communicated to it by the processor 30 by the use of bus 42. The device 12 includes a transmitter/receiver portion 50 which is coupled to the processor 30 by use of the bus 52 and is adapted to receive at least one signal 56 and generate at least one signal 58. That is, when the processor 30 desires to send information to another entity, the processor 30 may communicate data to the portion 50 and have the data included in the signal 58. That is, the signals 56, 58 may be of the radio frequency, infrared or “Bluetooth” type, however other signal types may be utilized. When another entity desires to communicate with the device 12, that other entity may send a signal 56 which is received by portion 50 and then communicated to the processor 30 by use of the bus 52. The portion 50 may selectively demodulate the signal 56 before transferring the information included within the signal 56 to the processor 30 and may selectively modulate the information received from the processor 30 before generating the signal 58. The device 12 further includes a keyboard 60 (which may be of the touchscreen variety) and an input/output portion 64 which is coupled to the keyboard 60 by the bus 65. The input/output portion 64 is coupled to the processor 30 by the use of bus 70. The keyboard 60 allows a user of the device 12 to generate information and the input/output portion 64 (along with busses 65, 70) allows the selectively generated information to be communicated to the processor 30. The power source 38 is coupled the processor 30, the memory 32, and the transmitter/receiver portion 50 by use of the bus 80 and provides operative power to these portions 30, 32, and 50. In one non-limiting embodiment of the inventions, the power source 38 comprises a battery. The portion 64 allows a bar code scanner 1 and a near field of communication receiver 300 to be respectively coupled to the processor 30, by busses 310 and 70. The scanner 1 could, in one non-limiting embodiment, scan an item to be purchased (e.g., such an item would be required to have bar code “scannable” type information placed upon it) and communicate the scannable type information to the processor 30 by use of busses 310, 70 and portion 64. The portion 64 can also receive data from an optical or image recognition device or “built-in camera” 400 (coupled to portion 64 by bus 401) that obtains information (such as the bar code of the item) pictographically or through optical character recognition, and the receiver 300 could receive payment information, from a transmitting assembly which was adapted to communicate with it. Such received payment information would be communicated to the processor by busses 310, 70 and portion 64. The at least one software application 17 may operatively reside within the memory assembly 32 and be accessible to the processor 30 by use of the bus 34.

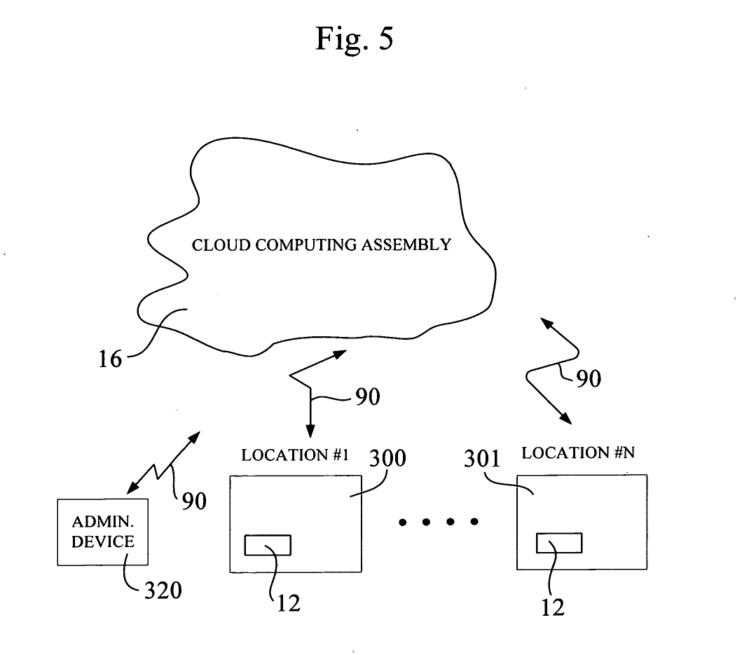

By way of example and without limitation, the signal 58 may be sent to the cloud computing assembly 16 and the signal 56 may be sent from the cloud computing assembly 16. In this manner, a two way or “bi-directional” communication link or channel 90 may be created by the use, in one non-limiting embodiment, by an internet router pair (not shown) which receives the signal 58 and communicates the received signal to the servers 15, and which receives the signal 56 from the servers 15 and communicates the received signal 56 to the at least one application 17. Thus, information may be shared and exchanged between the computing device 12 and the array of servers 15 within the cloud computing assembly 16 and it is this creation, information can also be shared between multiple devices (12) in the “internet” storing, processing, and sharing of information which allows a business enterprise to be managed and operated and this will be more fully delineated below, in accordance with the various non-limiting embodiments of the invention. It is this informational bi-directional flow which allows the various non-limiting embodiments of the inventions to be created and utilized. Further, multiple devices 12, as shown best perhaps in FIG. 5, may communicate with each other through the cloud assembly 16 and/or the network 14 and/or by direct communication (e.g., through a “Bluetooth” type network).

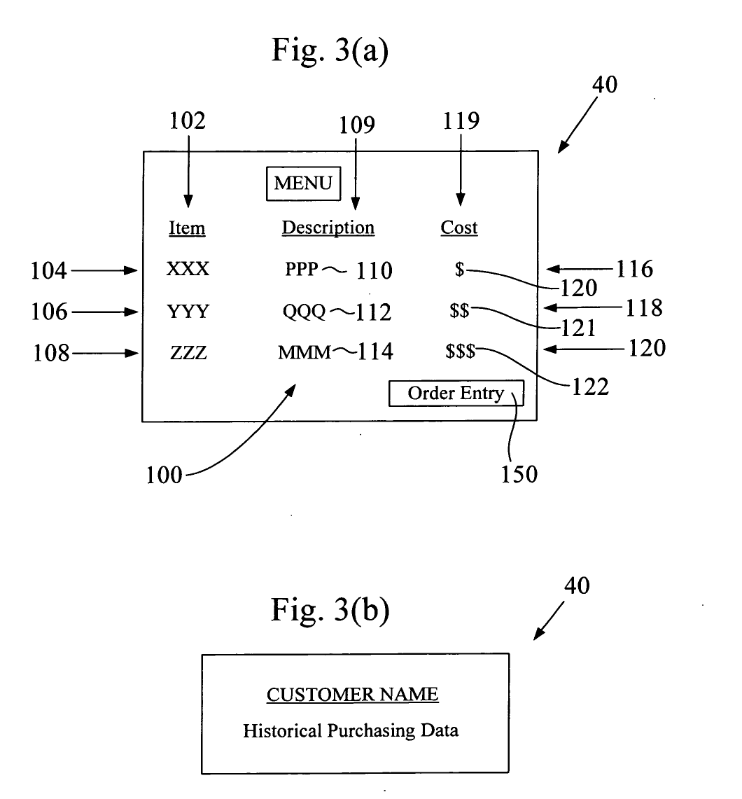

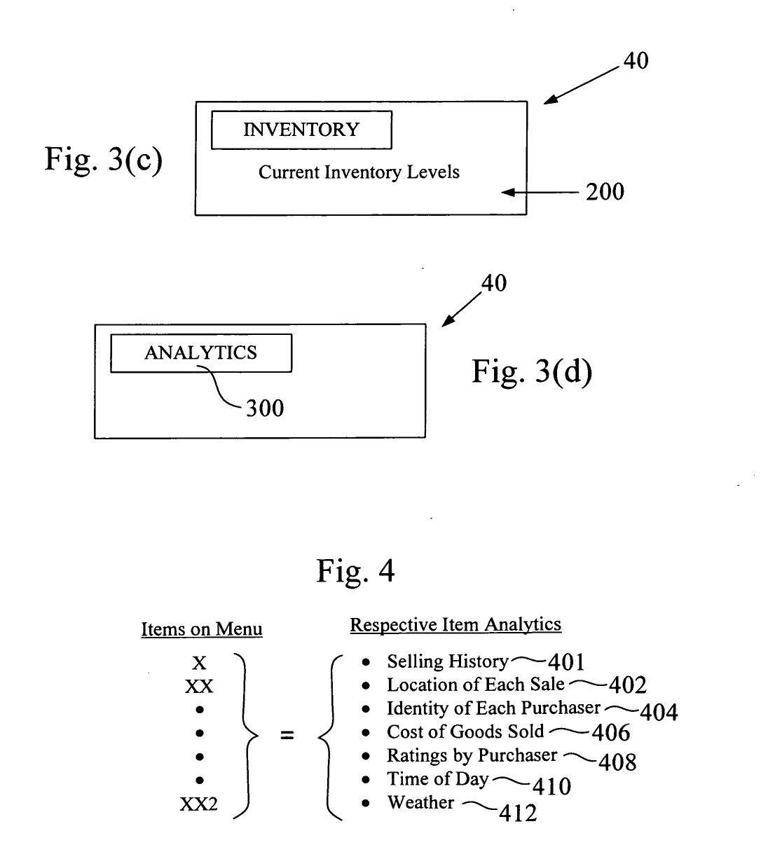

For example, as is best perhaps shown in FIG. 3(a), menu information 100 may be stored within the array of servers 15 (which cooperatively form the cloud assembly 16) and downloaded to the device 12 and then displayed upon the display portion 40 after such information 100 is received by the processor 30 (e.g., the menu information may be sent to the processor by use of signal 56, transmitter/receiver portion 50, and bus 52). The information 100 may be sent to the display portion 40 by use of bus 42. In one non-limiting example, the displayed information 100 includes a column 102 having entries 104, 106, 108 which respectively define unique menu items. The displayed information 100 may also include a second column 104 having entries 110, 112, 114 and each entry 110, 112, 114 respectively lies in a unique row 116, 118, 120 and each respective entry 110, 112, and 114 respectively describes the respective menu item 104, 106, 108. The displayed information 100 further include a third column 119 which has entries 120, 121, and 122 which respectively describe the price of respective menu items 104, 106,108. Thus, row 116 has entries 104, 110, and 120 which respectively define or name a menu item 104, describe the named menu item 104, and list a purchase price of the named menu item 104. Similarly, row 118 has entries 106, 112, and 121 which respectively define or name a menu item 106, describe the named menu item 106, and list a purchase price of the named menu item 106. Similarly, the row 120 has entries 108,114, 122 which respectively define or name the menu item 108, which described the menu item 108, and which lists a purchase price of the menu item 108. Thus, each row 116, 118, 120 is associated with a unique menu item. It should be appreciated that a greater or lesser number of rows and columns may be used and that a greater or lesser number of menu items may be displayed. Nothing in this description is meant to limit the number of menu items which may be displayed upon the display 40 and that multiple displays may be utilized, as well as different display formats. The menu information 100 may be created and/or modified and then communicated to servers 15 where such information resides until it is communicated to device 12. Nothing in this description is meant to limit menu information 100 to any particular format or contents.

A portion 150 of the display 40 may include a designated “order entry “portion and the display 40 may be of the “touch screen type”. That is, in one non-limiting embodiment, when an order is to be taken, the portion 150 is touched by a user of the device 12 along with whatever menu items 104, 106, 108 are to be ordered. When all of the items are selected (e.g., are “touched”), the portion 150 is touched again and the entire order (e.g., the menu items which have been previously designated or “touched” on the screen 40) are transmitted to the processor 30 where they are sent to servers 15 for archival storage. The information may also be sent to the input/output portion 64, by use of the bus 70, and then transmitted to a printer 155 which is coupled to the input/output portion 64 by use of the bus 157 where a bill is printed. The information may also be transmitted from the portion 64 to a monitor in a kitchen area to alert a cook or other portion to prepare the food and other menu items. In this “order taking “methodology”, an e-mail address of the user and/or other user information such as telephone number and social media information may be taken and this information is then sent, along with the associated order to the servers 15, and the bill may be electronically mailed to the customer by use of network 14. That is, a virtual keyboard 3 may be included with the display 40 and used to communicate the email and other types of information sent to the servers 15, along with the items selected which cooperatively form an order. A cash drawer 9 may be coupled to the input/output portion 64 by bus 7 and may be opened by the processor 30 to receive money and then closed by the processor 30 after the money is deposited in the drawer. The “opening” of the drawer may be done by remotely activating a solenoid or motor assembly by use of signals emanating from processor 30 and communicated to drawer 9 and the drawer 9 maybe thereafter selectively and manually closed. As used in this description, the term “social media information” means any information (such as a blog address or Facebook Account page identifier) which the customer uses to socially communicate with others.

It should be appreciated that, in one non-limiting embodiment, the device 12 may alter the menu items which are displayed upon the portion 40 by modifying the menu data contained within the servers 15 by use of the communications link or channel 90 or by any other communications link. It should further be appreciated that multiple numbers of the same item 104, 106, 108 may be ordered by touching that display of the item a number of distinct times equal to the number of that item which is to be ordered.

In addition to displaying menu items and allowing the items to be selectively ordered to thereby cooperatively create a bill, the device 12, as is best shown in FIG. 3(c), allows inventory to be tabulated by the owner and stored within the servers 15. Particularly, a user of the device 12 may periodically (e.g., at certain times of the day, such as in the morning and in the evening), take the device 12 (which in the most preferred embodiment of the invention is a tablet/laptop/smart phone/or other data available type computer) and respectively count and their respectively input the respective quantity or number of respective items residing within the business establishment. Inventory information 200 then communicates to the processor 30 by use of keyboard 60. The inventory information 200 is displayed on the display portion 40 and importantly is then communicated, by the use of channel 90 (or any other communications network/channel), to the servers 15 where it is stored and capable of being selectively downloaded and communicated to any device which is in communication with the servers 15. Thus, the same portable device 12 which can be carried by a user (e.g., store and/or restaurant employee) is capable of both dynamically creating an order as well as taking inventory and having the order and inventory information dynamically communicated to the servers 15 which operatively and cooperatively form the cloud computing assembly 16. The obtained social media information (for customers and others) may also be stored within the servers 15 and communicated to the device 12 where it may be selectively displayed. For example, to the social media associated with a current customer may be communicated to the device 12 used by the store clerk who is presently serving that customer (e.g., the customer's name has previously been communicated to the servers 15 upon initiation of an order being taken). In this manner, the social media information may be verified and the store (e.g., clerk) may even communicate or place information at their social media sites advertising that the customer just purchased products there. The social media information is placed on that customer's social media facility (e.g., as a tweet or a note on that customer's Facebook® page) in realtime, as that customer is making a purchase). It could, of course, be done after the purchase is completed.

Further, as is best perhaps shown in FIG. 3(b), because the orders, in one non-limiting embodiment of the invention are dynamically created and communicated to the servers 15 where they are stored, the device 12 can also request that the stored information be communicated to it by use of channel 90 (or by any other communications network or channel). This historical purchasing data can be associated with a desired time frame, a desired user (using the email address which has been provided or a tokenized credit card key) or targeted items. With this information, in another non-limiting embodiment of the invention, when an order is dynamically created and uploaded to the cloud assembly 16, the cloud assembly 16 may search historical data relative to the user who is associated with the current order (e.g., by use of the currently provided e-mail address or tokenized credit card key) and then communicate to the device 12 some additional suggested items that the customer has purchased in the past or that other customers have purchased with the recently ordered items. Thus, the user or employee is dynamically prompted to “up-sell” the customer on other items, thereby increasing the overall revenue of the business establishment. In this regard, historical sales information is used to “upsell” (e.g., have a customer purchase additional items selected by the user or employee).

Referring now to FIGS. 3(d) and 4, analytical information 300 may be communicated to the device 12, from the cloud assembly 16, and displayed upon the display portion 40. Some non-limiting examples of such analytical information 300 include, but are not limited to, selling history 401 of each menu item, the location of each sale 402, the identity of each purchaser 404, the cost of goods sold 406 for each sold menu item, the ratings of the item by each purchaser 408, the time of day that the sale was made 410, and the weather at the time and day of the sale 412. Thus, for the establishment in which the portable device 12 is used, historical data relative to sales levels for past days can be used to predict sales in the future (e.g., the amount of sales which occurred on the same day for the past three years can predict the sales which are expected to occur on that day in the current year). Further, the impact of weather can be analyzed (e.g., prior sales on a day in hot or non-rainy weather can be contrasted with sales levels for the same day in a different year in rainy weather). Hence, the analytical information can be used to allow a business owner to set the number of employees which are expected to be needed on a certain day and help the owner manage the labor costs and this also assists the owner to perform the scheduling of tasks. For example, knowing that a predetermined set of tasks must be accomplished and knowing the projected staffing levels, the owner is able to schedule these tasks to optimally make use of the scheduled staff. Moreover, weather data, such as various temperatures, can be associated with the amount of sales for each item and overall sales. Thus, a business owner, knowing a future temperature forecast for a future day can view historical sales data and overall sales data for that projected temperature in order to allow the business owner to plan the menu and the amount of needed employees for the future day. For example, if the temperature is forecast to be 100° F., less brewed coffee may be sold than if the forecasted temperature is 40° F.

Moreover, because the portable computer device is communicatively coupled to the Internet or global communications network 14, an owner or other individual can employ an application such as Skype® (or another type of custom communication service) and remotely and dynamically communicate directly with the employee who is utilizing the device 12 within the store or business establishment and provide direction or obtain/give certain information “on the fly”, or in “real-rime”, as the employees are actually working. An optical device (such as the camera 400) may receive visual information (not just limited to the scannable bar information on a product) and communicate this information to the servers 15 and/or to the display 40 when it is displayed to user of device 12.

What has been earlier described is the use of a single portable electronic device 12 in combination with the cloud assembly 16. It should be realized that in practice, multiple devices 12 may be used within a single store or retail location and that multiple stores may be managed by the use of the cloud assembly 16. A separate administration access may be created in order to allow only a certain user(e.g., an owner or manager) to have access to all of the information which is resident within the cloud assembly 16 and which is related to all of the stores for which data is obtained. Customers may also access their own information (e.g., items which they have purchased) and show this information with others, by electronic mail, smartphone, or by placing them into a blog on a website or by any other means, and they may rate their overall experience with the establishment where such items had been purchased. The employees may also access this information and communicate with each other to change schedules, swap shifts, request time off, and show information associated with the business. Customers may also remotely, by use of the cloud assembly 16, reserve seating or place advanced orders (e.g., take-out orders) and define the day and time such order are due to be ready.

Further, once an electronic mail is obtained of a customer, that electronic mail address in yet another non-limiting embodiment, can be used to determine that customer's address and social network contacts, such as those delineated within a social media site such as “Facebook”®. In this manner, the customer's contacts can then be sent advertisement for goods and services which have been purchased by that customer. Feedback, in yet another non-limiting embodiment, could also be solicited from the various customers and such feedback, such as that in the form of electronic mails, could be placed in a separate feedback database which is resident within the cloud assembly 16 and accessed by users of the system 10. The social contacts of a customer, in yet another non-limiting embodiment of the invention, not only get advertisement type material but they could also get the identity of items which their “friends” have purchased along with the feedback received from their “friends”. The device 12 could also be adapted to have a stored biometric print/signature (e.g., a thumbprint of each employee) and such biometric information may be required for a user or employee to use to sign-off or verify the changes to the system as a means of accountability. Every employee could touch the display 40 at the start and end of a respective work shift and the device 12 would accordingly “track” the hours of each employee and communicate this information to cloud assembly 16.

Further, supplier identity and ordering information may be resident within the cloud assembly 16 and if new items are needed within the business establishment or store, then the employee or user of the device 12 may then get the ordering information and place an order from the device 12. The order may either be directly and electronically mailed to the supplier or sent to the servers 15 where it is then verified and sent to the suppliers. In this manner, the same device which does inventory and management and commerce activities, also performs inventory ordering. Depending upon the store/business location, the cloud assembly 16 would direct the user to a specific vender and pre negotiated prices would have already been in place. The cloud assembly 16 could also request samples from suppliers, periodically and automatically re-bid or negotiate prices with suppliers and then notify the users of devices 12 which suppliers are to be used, and dynamically aggregate all orders or some of the orders from the various stores in order to reduce shipping costs. Also, the cloud assembly 16 could give analytical data for selected groups of stores. The device 12 could send and create, dynamically and in “real time” information to any social networking site, at any time, by use of cloud assembly 16 and/or global communications network 14. Further, a user of the system 16 could also send invitations to other potential supplies requesting samples and requesting such invited supplies to bid on providing products to the establishment. This could be accomplished by electronic mail.

In another non-limiting embodiment of the invention, the data associated with the various locations is communicated to the device 12 from the system 16 and is presented to the user of device 12 as a play list which, in one non-limiting embodiment, is a list of locations which are sometimes organized into groups and which may be selectively displayed as groups. That is, respective information categories for pricing, menus, and sales data for each respective location may be displayed to the user. For example, as shown in FIG. 5, each location 300, 301 has at least one assembly 12 which operates in combination with the cloud assembly 16 in the manner previously described. Yet another administrative assembly 320 (which may be substantially similar to a device 12) may communicate with assembly 16 and obtain the entire data resident within assembly 16.

In yet another non-limiting embodiment of the invention, competitive sales data is placed within the system 16 and selectively communicated to the device 12. Further, device 12 may, upon request, receive “real time” sales data (in a “real time” stream”) from each location which is selected and such real time “real time” data including inventory as well as sales data.

Further, in yet another non-limiting embodiment of the invention, the device 12, through the Internet, or our on-site router, will find, connect and communicate with devices outside of the device 12 such as smartphones nearby. It will mainly connect with these devices to relay menu information, coupons and reviews of the store to the smartphone (or other device like a laptop or tablet) that are within a certain geographic proximity to the store. For example, knowing the cellular telephone number of customers allows the device 12 to create and send “SMS” type messages to the cellular telephones of these customers providing the desired information to the customer. If the customers allow system 10 to track their location by use of the global positioning system resident within their respective mobile phones, then the system 10 will only send respective SMS messages to those in close geographic proximity to the commercial establishment where the device 12 is being utilized or when they are respectively close to certain other establishments locations. Alternatively or concomitantly the messages could generated and transmitted by cloud 16

It is to be understood that the present inventions are not limited to the exact construction and methodology which has been delineated above, but that various changes and modifications may be made without departing from the spirit and the scope of the various inventions as they are more fully delineated in the following claims.

What is claimed is:

1) A system having a processor portion; a communication portion which is coupled to said processor portion; and a display portion which is coupled to said processor portion and wherein said processor portion contains first information which represents a respective quantity of items which are resident within a business establishment and which causes said first information to be selectively communicated to and displayed upon said display portion, and wherein said processor portion further contains second information which represents a plurality of items which are for sale along with a respective price for each of said plurality of items, and wherein said processor causes said second information to be selectively communicated to and displayed upon said display portion, and wherein said display portion allows an order to be selectively created by allowing for at least one of said plurality of items to be selected and which further communicates said order to said processor portion which creates a bill and saves the order information.

2) A system comprising a first portion which receives and stores inventory information, menu item information, the identity of a plurality of customers, and the respective menu items purchased by each of said respective plurality of customers over a certain period of time; a display portion which is coupled to said first portion and which selectively displays aid inventory information, said menu item information, said identity of said plurality of customers, and the respective menu items purchased by each of said respective plurality of customers, wherein said display portion allows an order to be created by the selection of at least one of said displayed menu items; a third portion which is coupled to said first portion and to said display portion and which generates an invoice associated with said order and which electronically mails said invoice to one of said plurality of customers; and a cash register portion which is coupled to said first portion and which selectively opens and closes and which receives money associated with said invoice.

3) The system of claim 2 further comprising a fourth portion which allows employers to communicate with others.

4) The system of claim 2 further comprising a fourth portion which allows employees to communicate with others.

5) A method for managing inventory and selling items comprising the steps of obtaining inventory information; storing said obtained inventory information; updating said inventory information; replacing said stored inventory information with said updated inventory information; displaying said updated inventory information on a computing device; creating a menu which comprises a list of items and the respective purchase prices respectively associated with each of said items; storing said menu; displaying said menu upon said computing device; creating an order comprising certain items which are selected by use of said displayed menu; creating a bill by use of said computing device; electronically mailing said created bill to a customer; receiving payment for said order; and delivering said order.
